(19) United States
(12) Patent Application Publication
(10) Pub. No.: US 2025/0373927 A1
(43) Pub. Date: Dec. 4, 2025

(54) IMAGING APPARATUS, METHOD OF CONTROLLING IMAGING APPARATUS, AND NON-TRANSITORY COMPUTER READABLE MEDIUM

(71) Applicant: CANON KABUSHIKI KAISHA, Tokyo (JP)

(72) Inventor: KENTARO WATANABE, Kanagawa (JP)

(21) Appl. No.: 19/211,377

(22) Filed: May 19, 2025

(30) Foreign Application Priority Data
May 28, 2024 (JP) 2024-086068

(51) Int. Cl. H04N 23/611; H04N 23/67

(52) U.S. Cl. CPC H04N 23/611; H04N 23/675

(57) ABSTRACT

An imaging apparatus acquires an image of a subject, detects a first portion and a second portion of the subject from the image, execute an area setting process of setting an arbitrary area in the image as a search area, and sets any one of the first portion and the second portion as a target for image processing in accordance with overlapping between an area representing the detected first portion and an area representing the detected second portion and the search area. When an area acquired by excluding a reduced area acquired by reducing the area representing the first portion from the area representing the first portion overlaps the search area, the first portion is not set as the target, and when the reduced area overlaps the search area, the first portion is set as the target.

### CROSS-REFERENCE TO PRIORITY APPLICATION

This application claims the benefit of Japanese Patent Application No. 2024-086068, filed on May 28, 2024, which is hereby incorporated by reference herein in its entirety.

### BACKGROUND

### Field of the Technology

The present disclosure relates to an imaging apparatus, a method of controlling an imaging apparatus, and a non-transitory computer readable medium.

### Description of the Related Art

In recent years, it has become common for digital cameras to have a function for detecting a subject from the image signal continuously output from an imaging element and taking a picture of that subject by adjusting an appropriate state of focus, brightness, and color to the optimal conditions.

It has also become common to detect multiple portions of a single subject, and, for example, technologies for detecting pupils, a face, a head part, and a body, and the like of a person as a subject and using them for photography are also used. In Japanese Patent Application Laid-open No. 2023-128820, in an imaging apparatus that detects multiple portions of a subject, a first portion and a second portion are associated with each other, and, for example, when a search area corresponding to an autofocus (AF) area is brought into contact with an area of one portion, the second portion is set as a target for a focusing process and the like.

In the technology disclosed in Japanese Patent Application Laid-open No. 2023-128820, also in a case in which the second portion is not present inside of the AF area, the second portion is set as a target for a focusing process and the like. However, in a case in which a user expects a focusing process and the like for a portion present within the AF area, it is undesirable to perform a focusing process and the like on a portion disposed outside of the AF area.

Thus, for example, a method in which a detected portion disposed outside of the AF area is not set as a target for a focusing process and the like, and a target for a focusing process and the like is determined from detected portions overlapping the AF area may be considered.

In a case in which a target for a focusing process and the like is determined from detected portions overlapping the AF area using the method described above, in a state in which the AF area and an area of a detected portion are in contact with each other, there is a possibility of a state in which the AF area and the area of the detected portion are in contact with each other and a state in which they are separated from each other being repeated in accordance with positional variations of the detected portion. As a result, a target for a focusing process and the like is frequently switched in an imaging apparatus, and there is a possibility that flickering will occur on a display screen.

### SUMMARY

The present disclosure is in view of the situations described above, and the present disclosure is directed to provide a technology for suppressing unnecessary switching of a main portion in a captured image.

According to some embodiments, an imaging apparatus includes a processor and a memory storing a program which, when executed by the processor, causes the imaging apparatus to execute an acquisition process of acquiring an image of a subject, execute a detection process of detecting a first portion and a second portion of the subject from the image, execute an area setting process of setting an arbitrary area in the image as a search area, and execute a target setting process of setting any one of the first portion and the second portion as a target for image processing in accordance with overlapping between an area representing the first portion and an area representing the second portion, which are detected by the detection process, and the search area, wherein, in the target setting process, in a state in which the first portion is not set as the target, even when an area acquired by excluding a reduced area acquired by reducing the area representing the first portion from the area representing the first portion overlaps the search area, the first portion is not set as the target, and when the reduced area overlaps the search area, the first portion is set as the target.

According to some embodiments, an imaging apparatus includes a processor and a memory storing a program which, when executed by the processor, causes the imaging apparatus to execute an acquisition process of acquiring an image of a subject, execute a detection process of detecting two or more portions of the subject from the image, execute an area setting process of setting an arbitrary area in the image as a search area, execute a target setting process of setting any one of the two or more portions as a target for image processing in accordance with overlapping between an area representing each of the two or more portions detected in the detection process and the search area, and execute a priority level setting process of setting a priority level relating to setting of the target to the two or more portions detected by the detection process, wherein, in the target setting process, in a case in which two or more areas among a plurality of areas representing a plurality of portions overlap the search area, the portion with highest priority level out of the two or more portions corresponding to the two or more areas is set as the target, in the target setting process, in a state in which another portion with a priority level higher than that of the portion set as the target is not set as the target, even when an area acquired by excluding a reduced area acquired by reducing the area representing the other portion from the area representing the other portion overlaps the search area, the other portion is not set as the target, and when the reduced area overlaps the search area, the other portion is set as the target.

According to some embodiments, a method of controlling an imaging apparatus includes an acquisition step of acquiring an image of a subject; a detection step of detecting a first portion and a second portion of the subject from the image; an area setting step of setting an arbitrary area in the image as a search area; and a target setting step of setting any one of the first portion and the second portion as a target for image processing in accordance with overlapping between an area representing the first portion and an area representing the second portion, which are detected in the detection step, and the search area, wherein, in the target setting step, in a state in which the first portion is not set as the target, even when an area acquired by excluding a reduced area acquired by reducing the area representing the first portion from the area representing the first portion overlaps the search area, the first portion is not set as the target, and when the reduced area overlaps the search area, the first portion is set as the target.

According to some embodiments, a method of controlling an imaging apparatus includes an acquisition step of acquiring an image of a subject; a detection step of detecting two or more portions of the subject from the image; an area setting step of setting an arbitrary area in the image as a search area, and a target setting step of setting any one of the two or more portions as a target for image processing in accordance with overlapping between an area representing each of the two or more portions detected in the detection step and the search area, a priority level setting step of setting a priority level relating to setting of the target to the two or more portions detected in the detection step, wherein, in the target setting step, in a case in which two or more areas among a plurality of areas representing a plurality of portions overlap the search area, the portion with a highest priority level out of the two or more portions corresponding to the two or more areas is set as the target, in the target setting step, in a state in which another portion with a priority level higher than that of the portion set as the target is not set as the target, even when an area acquired by excluding a reduced area acquired by reducing the area representing the other portion from the area representing the other portion overlaps the search area, the other portion is not set as the target, and when the reduced area overlaps the search area, the other portion is set as the target.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a schematic configuration of an imaging apparatus according to a first embodiment.

FIG. 2 is a flowchart illustrating an example of a process executed by the imaging apparatus according to the first embodiment.

FIGS. 3A and 3B are diagrams schematically illustrating a process of an imaging apparatus according to a conventional technology.

FIGS. 4A to 4C are diagrams schematically illustrating a process of the imaging apparatus according to the first embodiment.

FIGS. 5A and 5B are diagrams schematically illustrating a process of an imaging apparatus according to a modified example.

FIG. 6 is a flowchart illustrating an example of a process executed by an imaging apparatus according to a modified example.

### DESCRIPTION OF THE EMBODIMENTS

Hereafter, forms for performing the present disclosure will be described in detail with reference to the accompanying drawings. Embodiments described below are examples of means for realizing the present disclosure and may be modified or changed as appropriate depending on configurations of devices and various conditions to which the present disclosure is applied. The embodiments can be combined as appropriate. In description of the following embodiments, it is assumed that an imaging apparatus has a function for detecting a face and an upper half body of a person in an image, setting a portion overlapping a search area as a main portion, and performing an in-focus process on the main portion.

### First Embodiment

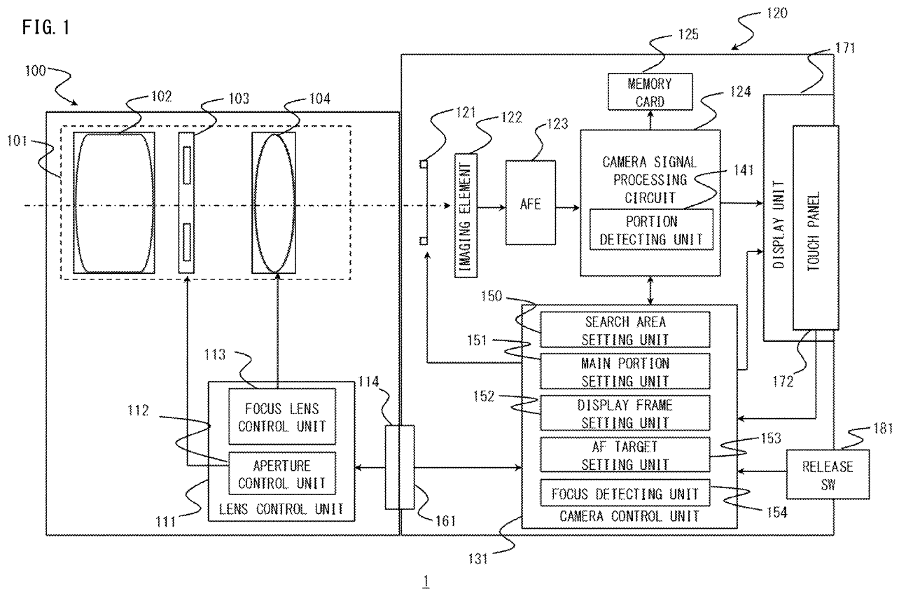

FIG. 1 is a diagram illustrating a configuration example of an imaging apparatus 1 according to a first embodiment of the present disclosure and illustrates a mirrorless camera (hereinafter referred to as “camera”) equipped with a function for setting a foremost subject when viewed from the imaging apparatus 1 as a main subject. Hereinafter, each constituent element constituting the imaging apparatus 1 will be described.

An interchangeable lens 100 is one of optical devices that can be mounted in a camera main body unit 120. The interchangeable lens 100 includes a photography lens unit 101 including a main photography optical system 102, an aperture 103 that adjusts the amount of light, and a focus lens group 104 that adjusts the focus.

A microcomputer for controlling a lens system of the interchangeable lens 100 (hereinafter, referred to as a lens control unit 111) includes an aperture control unit 112 that controls the operation of the aperture 103, a focus lens control unit 113 that controls the operation (drive) of the focus lens group 104. The focus lens control unit 113 drives the focus lens group 104 in the direction of an optical axis of the photography lens unit 101 and performs focus adjustment of the camera on the basis of focus lens drive information acquired from the camera main body unit 120.

The focus lens group 104 may have a plurality of focus lenses or may have only one focus lens. In FIG. 1, for simplification, although a single focus lens is illustrated as an example of an interchangeable lens, it may be a lens with a changeable focal length (zoom lens). In a case in which the focus lens group 104 includes a zoom lens, the focus lens control unit 113 acquires focal length information from an encoder output detecting a zoom lens position. In addition, in a case in which the focus lens group 104 includes a lens with a camera shake correction function, the focus lens control unit 113 also controls a shift lens group for camera shake correction and the like.

The camera main body unit 120 includes a shutter 121 used for exposure control and an imaging element 122 such as a complementary metal oxide semiconductor (CMOS) sensor. An imaging signal output by the imaging element 122 is processed by an analog signal processing circuit 123 and then is sent to a camera signal processing circuit 124.

A camera system control microcomputer (hereinafter referred to as a camera control unit) 131 of the camera main body unit 120 controls the entire imaging apparatus 1. For example, the camera control unit 131 drives a shutter 121 by controlling drive of a shutter driving motor not illustrated in the drawing. A memory card 125 is a recording medium that records data of a captured image. Information indicating a pressed state of a release switch 181 operated by a user of the imaging apparatus 1 is sent to the camera control unit 131, and the captured image is stored in the memory card 125 in accordance with the pressed state.

A display unit 171 includes a display device such as a liquid crystal panel (LCD) that displays an image to be captured using a camera by a user or displays a captured image. A touch panel 172 is an operation unit that allows a user to designate coordinates on the display unit 171 using a finger or a stylus and can be configured to be integrated with the display unit 171. For example, the touch panel 172 is configured such that light transmittance does not interfere with the display of the display unit 171 and can be configured as a built-in type (in-cell type) that is built into the inside of a display surface of the display unit 171 or the like. Input coordinates on the touch panel 172 are associated with display coordinates on the display unit 171. In accordance with this, a graphical user interface (GUI) allowing a user to feel as if he or she can directly manipulate a screen displayed on the display unit 171 can be configured. The operation state for the touch panel 172 is managed by the camera control unit 131.

The camera main body unit 120 includes a mount contact part 161, which is a communication terminal for communicating with the interchangeable lens 100, on the mount surface for the interchangeable lens 100. The interchangeable lens 100 includes a mount contact part 114, which is a communication terminal for communicating with the camera main body unit 120, on the mount surface for the camera main body unit 120.

The lens control unit 111 and the camera control unit 131 controls communication to perform serial communication at a predetermined timing through the mount contact parts 114 and 161. As a result, focus lens driving information, aperture driving information, and the like are sent from the camera control unit 131 to the lens control unit 111, and optical information such as focal length is sent from the lens control unit 111 to the camera control unit 131.

The camera signal processing circuit 124 includes a portion detecting unit 141 as a block according to this embodiment. The portion detecting unit 141 detects a face portion of a person as a subject from a captured image and outputs detected information. In addition, the portion detecting unit 141 detects an upper half body portion of a person from the image and outputs detected information. The detection results acquired by the portion detecting unit 141 are sent to the camera control unit 131.

The camera control unit 131 has a search area setting unit 150 that sets a search area on the basis of coordinates of the AF area and the like displayed on the display unit 171. In addition, the camera control unit 131 has a main portion setting unit 151 that sets one portion of a subject in the image as a main portion to focus on in the subject. As an example, the main portion setting unit 151 sets one of the face and the upper half body of the subject as a main portion on the basis of the detected results received from the portion detecting unit 141. Alternatively, the main portion setting unit 151 may not set a main portion for this subject (no main portion is assumed to be present).

The camera control unit 131 has a display frame setting unit 152 that displays an AF area and a subject detection frame for an image displayed on the display unit 171. Furthermore, the camera control unit 131 has an AF target setting unit 153 that notifies the focus detecting unit 154 of an area of a main portion as an in-focus target according to AF. The focus detecting unit 154 performs a focus detecting process within the area of the main portion on the basis of an image signal indicating an in-focus target notified by the AF target setting unit 153. Here, the focus detecting process is performed, for example, using a known phase difference detection equation, a contrast detection equation, and the like. In a case in which the focus detecting process is executed using the phase difference detection equation, the focus detecting unit 154 executes a process of calculating the amount of image misalignment by performing a correlation operation on one pair of image signals having disparity or a process of further converting the amount of image misalignment into a defocus amount. Furthermore, the focus detecting unit 154 can convert the defocus amount to a focus lens drive amount on the basis of sensitivity at the time of driving the interchangeable lens 100, and the like.

The camera control unit 131 transmits the focus lens drive amount detected by the focus detecting unit 154 to the lens control unit 111. The focus lens control unit 113 controls the drive of the focus lens on the basis of focus lens drive information received from the camera control unit 131. The aperture control unit 112 controls the aperture of the lens on the basis of an aperture amount received from the camera control unit 131.

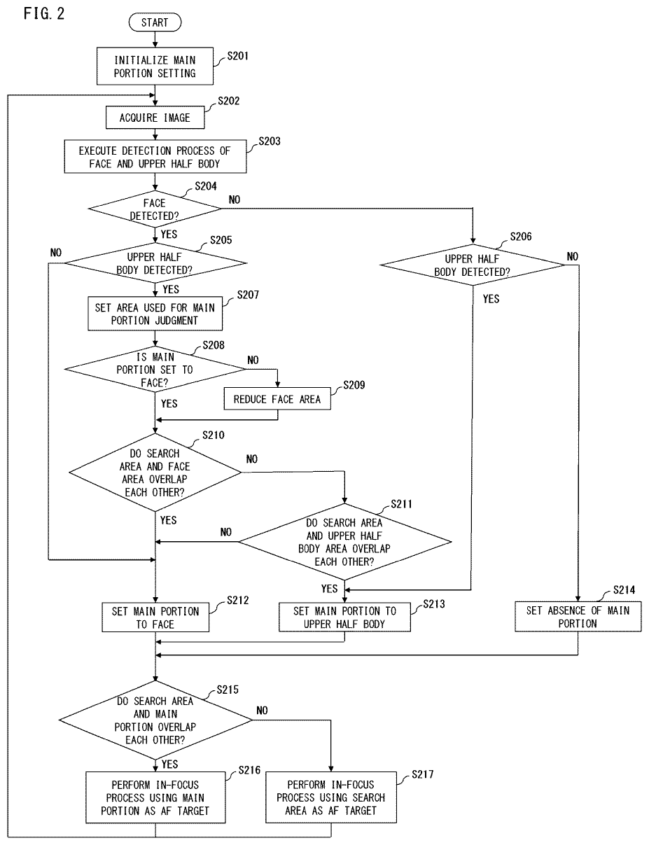

Next, a process executed by the imaging apparatus 1 in this embodiment will be described. FIG. 2 illustrates a flowchart of the process executed by the imaging apparatus 1 in this embodiment. FIG. 2 illustrates an example of a process in which the camera control unit 131 of the imaging apparatus 1 detects a face and an upper half body of a subject from an acquired image after startup of the imaging apparatus 1, sets a main portion, and executes the in-focus process for the main portion.

In Step S201, the main portion setting unit 151 sets a state in which a main portion has not been set in the acquired image (a main portion absent state). The process of Step S201 is a process of initializing the main portion setting before acquiring an image for the first time after the startup of the imaging apparatus 1.

Next, in Step S202, a subject is imaged by the imaging apparatus 1, and a signal taken in from the imaging element 122 is processed by an analog signal processing circuit 123. Then, a signal output from the analog signal processing circuit 123 is sent to the camera signal processing circuit 124. In accordance with this, an image of the subject is acquired by the camera signal processing circuit 124. Here, the camera signal processing circuit 124 is a means for acquiring an image of a subject. In Step S202, the search area setting unit 150 is an area setting means that sets an arbitrary area within the acquired image as a search area. For example, the search area setting unit 150 sets a search area to overlap the AF area within the image. In addition, the search area setting unit 150 changes the position of the search area in accordance with movement of the AF area within the image.

Next, in Step S203, the portion detecting unit 141 executes the process of detecting a face and an upper half body of a subject for the image acquired in Step S202. A detection result for a face of a subject and a detection result for an upper-half body of a subject acquired by the portion detecting unit 141 are sent to the camera control unit 131. Here, a face of a subject is a first portion of the subject, and an upper half body of a subject is a second portion of the subject. The portion detecting unit 141 is a detection means that detects the first portion and the second portion of a subject from an image.

Next, in Step S204, the camera control unit 131 determines whether or not detection of a face of a subject has been successful on the basis of the detection result acquired in Step S203. In a case in which it is determined that a face of a subject has been detected in the image, in other words, detection of a face of a subject has been successful (S204: Yes), the camera control unit 131 causes the process to proceed to Step S205. In addition, in a case in which it is determined that a face of a subject has not been detected in the image, in other words, detection of a face of a subject has failed (S204: No), the camera control unit 131 causes the process to proceed to Step S206.

In Step S205, the camera control unit 131 determines whether or not detection of an upper half body of a subject has been successful on the basis of the detection result acquired in Step S203. In a case in which it is determined that an upper half body of a subject has been detected in the image, in other words, detection of an upper half body of a subject has been successful (S205: Yes), the camera control unit 131 causes the process to proceed to Step S207. In addition, in a case in which it is determined that an upper half body of a subject has not been detected in the image, in other words, detection of an upper half body of a subject has failed (S205: No), the camera control unit 131 causes the process to proceed to Step S212.

In Step S206, similar to Step S205, the camera control unit 131 determines whether or not the detection of an upper half body of a subject has been successful on the basis of the detection result acquired in Step S203. In a case in which it is determined that the detection of an upper half body of a subject has been successful (S206: Yes), the camera control unit 131 causes the process to proceed to Step S213. In addition, in a case in which it is determined that the detection of an upper half body of a subject has failed (S206: No), the camera control unit 131 causes the process to proceed to Step S214. While a detection result of an upper half body is determined in a situation in which detection of a face has been successful in the process of Step S205, a detection result of an upper half body is determined in a situation in which detection of a face has failed in the process of Step S206, which is different from the process of Step S205.

In Step S207, the main portion setting unit 151 sets an area used to set the main portion on the basis of the face and the upper half body detected in the image acquired in Step S202. In this embodiment, as an example, the main portion setting unit 151 sets a face detection area and an upper half body detection area detected by the portion detecting unit 141 in Step S203 as areas used to set the main portion as they are.

Next, in Step S208, the camera control unit 131 determines whether or not the current main portion is set to a face. In a case in which the main portion is set to the face (S208: Yes), the camera control unit 131 causes the process to proceed to Step S210. In addition, in a case in which the main portion is not set to the face (S208: No), the camera control unit 131 causes the process to proceed to Step S209. At the time of an operation performed for the first time after the startup of the imaging apparatus 1, the main portion setting is initialized in Step S201, and there is no main portion, in other words, a state in which the main portion is not set to the face is formed. For this reason, when Step S208 is executed for the first time after startup of the imaging apparatus 1, the process proceeds from Step S208 to Step S209.

In Step S209, the camera control unit 131 reduces the face detection area used for main portion determination. The amount of reduction of the face detection area in Step S209 may be constant or may be determined in accordance with the size of the detection area or the search area.

Next, in Step S210, the camera control unit 131 determines whether or not the search area and the face detection area overlap each other. In a case in which it is determined that the search area and the face detection area overlap each other (S210: Yes), the camera control unit 131 causes the process to proceed to Step S212. In addition, in a case in which it is determined that the search area and the face detection area do not overlap each other (S210: No), the camera control unit 131 causes the process to proceed to Step S211.

In Step S211, the camera control unit 131 determines whether or not the search area and the upper half body detection area overlap each other. In a case in which it is determined that the search area and the upper half body detection area overlap each other (S211: Yes), the camera control unit 131 causes the process to proceed to Step S213. In addition, in a case in which it is determined that the search area and the face detection area do not overlap each other (S211: No), the camera control unit 131 causes the process to proceed to Step S212.

In Step S212, the main portion setting unit 151 sets the main portion in the captured image acquired in Step S202 as a face of the subject. In addition, the display frame setting unit 152 displays a subject detection frame, which indicates the area of the face of the subject that becomes the main portion, on the display unit 171. The display frame setting unit 152 is a display means that displays a frame corresponding to the portion set as the main portion. Furthermore, in a case in which the face detection area used for determination of the main portion is reduced in Step S209, the camera control unit 131 returns the face detection area used for main portion determination to the detection area before reduction. Thus, in this embodiment, the face detection area that has been reduced is used in the determination process of Step S210, and, after the main portion is set to the face, the size of the face detection area is returned to the original size. In accordance with this, according to the imaging apparatus 1, a phenomenon of frequent switching of the main portion setting due to frequent switching of overlapping between the search area and the detection area caused by camera shake or the like in a case in which the size of the detection area is not changed can be reduced. Then, the camera control unit 131 causes the process to proceed to Step S215.

In this embodiment, as the area of the face to be displayed as a subject detection frame in the image in Step S212, not the area reduced in Step S209 but the face detection area that has not been reduced is used. In addition, in a case in which it is determined that the search area and the area of the face overlap each other in Step S210, and the process proceeds to Step S212, the main portion is set to the face without performing the process of determining whether or not the search area and the area of the upper half body overlap each other in Step S211. In other words, the main portion setting unit 151 sets the face as the main portion in a case in which both the face detection area and the upper half body detection area overlap the search area. In accordance with this, in the imaging apparatus 1, in a case in which the search area overlaps both the area of the face and the area of the upper half body, the face is preferentially set as the main portion.

In addition, in this embodiment, in a case in which the search area does not overlap any one of the face detection area and the upper half body detection area, the imaging apparatus 1 causes the process to proceed in order of Step S210 (No), Step S211 (No), and Step S212. Thus, in a case in which neither the face detection area nor the upper half body detection area overlaps the search area, the main portion setting unit 151 sets the face as the main portion. In accordance with this, in the imaging apparatus 1, in a case in which the search area does not overlap any one of the area of the face and the area of the upper half body, the face is preferentially set as the main portion.

In Step S213, the main portion setting unit 151 sets the main portion in the captured image acquired in Step S202 to the upper half body of the subject. In addition, the display frame setting unit 152 displays a subject detection frame, which indicates the area of the upper half body of the subject that becomes the main portion, on the display unit 171. Furthermore, in a case in which the face detection area used for the main portion determination is reduced in Step S209, the camera control unit 131 returns the face detection area used for the main portion determination to the detection area before reduction. Then, the camera control unit 131 causes the process to proceed to Step S215. In this embodiment, the main portion setting unit 151 is a target setting means that, in accordance with overlapping between the area indicating a detected portion and the search area, sets this portion as a target for image processing.

In Step S214, the main portion setting unit 151 sets absence of the main portion. In accordance with this, a state in which no main portion has been set in the captured image acquired in Step S202 is formed. Then, the camera control unit 131 causes the process to proceed to Step S215.

In Step S215, the camera control unit 131 determines whether or not the search area and the area of the main portion set in Step S212 or Step S213 overlap each other. In a case in which it is determined that the search area and the area of the main portion set in Step S212 or Step S213 overlap each other (S215: Yes), the camera control unit 131 causes the process to proceed to Step S216. In addition, in a case in which it is determined that the search area and the area of the main portion set in Step S212 or Step S213 do not overlap each other (S25: No), the camera control unit 131 causes the process to proceed to Step S217. In addition, in a case in which Step S215 is executed in a state in which no main portion is set in Step S214, the camera control unit 131 determines that the search area and the area of the main portion do not overlap each other and causes the process to proceed to Step S217. The determination process of Step S215 can also be executed in accordance with determination results acquired in Steps S204, S205, S206, S210, and S211. For this reason, the camera control unit 131 may store the determination results of Steps S204, S205, S206, S210, and S211 and perform the determination process on the basis of the stored determination results in Step S215.

Next, in Step S216, the AF target setting unit 153 sets the area of the main portion as the AF target in the captured image acquired in Step S202 and performs an in-focus process. After the completion of the in-focus process, the camera control unit 131 returns the process to Step S202, acquires a captured image of a next frame, and repeats the process described above. After the completion of Step S216, the main portion that has been set is not reset, and the process proceeds to image processing of a next frame in a state in which the setting of the main portion is maintained.

In Step S217, the AF target setting unit 153 sets the search area as the AF target in the captured image acquired in Step S202 and performs an in-focus process. Thus, according to this embodiment, in the imaging apparatus 1, in a case in which neither the face nor the upper half body is set as the main portion, the main portion setting unit 151 sets the search area as the target area for the in-focus process. In addition, also in a case in which the face or the upper half body is set as the main portion, and a detection area of a portion set as the main portion out of the face detection area and the upper half body detection area does not overlap the search area, the main portion setting unit 151 sets the search area as a target area for the in-focus process. After the completion of the in-focus process, the camera control unit 131 returns the process to Step S202, acquires a captured image of a next frame, and repeats the process described above. In addition, after the completion of Step S216, in a state in which the main portion that has been set is not reset, and the setting of the main portion is maintained, the process processes to image processing of a next frame.

As described above, according to the imaging apparatus 1 of this embodiment, the face and/or the upper half body of a person that is a subject in the captured image is detected, and when the search area overlaps the face area, the face is preferentially set as the main portion. In a state in which the face is not set as the main portion, the imaging apparatus 1 does not set the face as the main portion even when an area acquired by excluding a reduction area acquired by reducing a detection area indicating a face from the detection area indicating a face overlaps the search area, and when the reduction area overlaps the search area, it sets the face as the main portion. Thus, according to the imaging apparatus 1, while the main portion is not set to the face, the face detection area is reduced, and the main portion determination is performed, and thus, the phenomenon of frequent switching of the main portion can be reduced. A portion to be detected is not limited to the face and the upper half body of a subject, a head part, a body, or other arbitrary portions of a subject may be detected, and the number of portions to be detected may be appropriately changed.

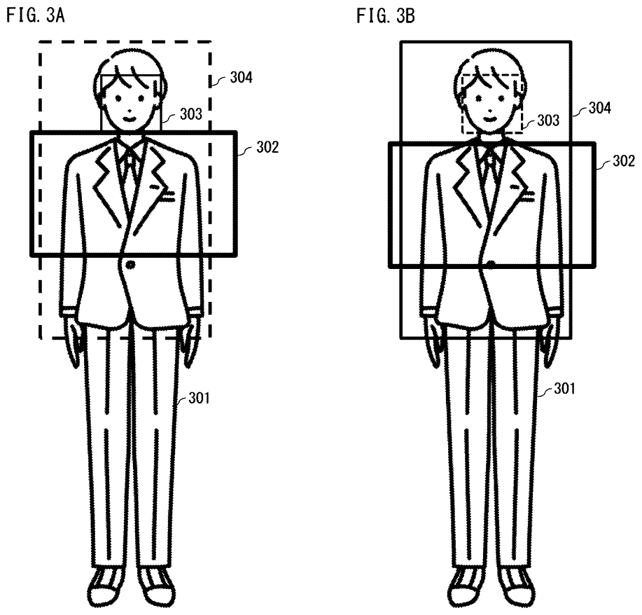

Next, a specific examples of image processing performed by the imaging apparatus 1 according to this embodiment will be described. First, FIGS. 3A and 3B schematically illustrate setting of the main portion in an imaging apparatus relating to a conventional technology. In the examples illustrated in FIGS. 3A and 3B, the face detection area is not reduced in main portion determination for a captured image. FIG. 3A illustrates an example of a subject 301 depicted in the captured image. FIG. 3A illustrates a state in which a search area 302 overlaps a detection area 303 of the face and a detection area 304 of the upper half body. At this time, a face of a subject 301 is set as the main portion. In the case of FIG. 3A, in the imaging apparatus, a frame of the face of the same position and the same size as those of the detection area 303 of the face is displayed, and a frame of the upper half body is not displayed.

FIG. 3B illustrates an example of a state in which the search area 302 has moved from the state illustrated in FIG. 3A due to a user's operation on the imaging apparatus such as camera shake or the like. FIG. 3B illustrates the state in which the search area 302 does not overlap the detection area 303 of the face but overlaps the detection area 304 of the upper half body. In this case, the upper half body of the subject 301 is set as the main portion. In the case illustrated in FIG. 3B, in the imaging apparatus, a frame of the upper half body is displayed in the same position and the same size as those of the upper half body detection area 304 is displayed, and a frame of the face is not displayed.

In this way, in the imaging apparatus according to the conventional technology, a subject depicted in a captured image can be easily switched between the state illustrated in FIG. 3A and the state illustrated in FIG. 3B due to effects of subject movement, camera shake of the user, and the like. As a result, flickering occurs in a displayed image due to a change in the display frame accompanying the switching of the main portion for a subject. In addition, in the imaging apparatus, there is a likelihood of the positional variations of each portion causing the flickering to be intensive depending on the degree of subject movement, camera shake of the user, and the like. When the flickering becomes intensive, the focus becomes unstable in the AF process, and switching of the display of an AF target area to be notified to the user frequently occurs, and there is concern that the visibility of the image on the display screen deteriorates.

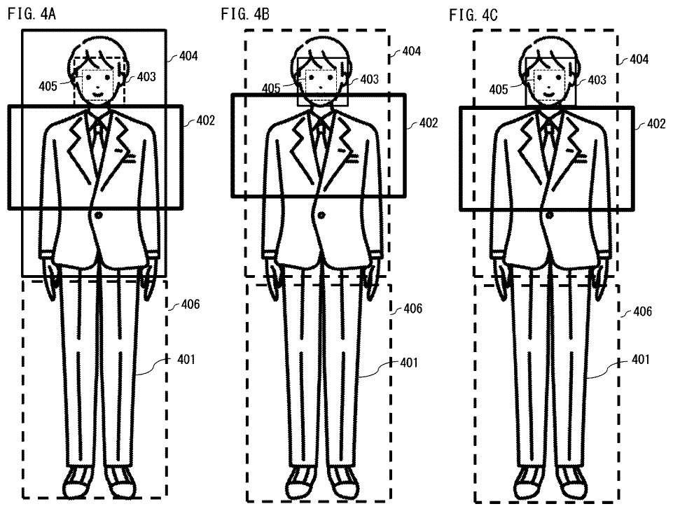

FIGS. 4A to 4C schematically illustrate the setting of a main portion in an image according to the imaging apparatus 1 of this embodiment. FIGS. 4A to 4C illustrate an example of a subject 401 depicted in a captured image in the imaging apparatus 1. FIG. 4A illustrates a state in which an upper half body of the subject 401 is set as a main portion. In FIG. 4A, a face detection area is reduced in main portion determination (an area 405 in the drawing), and overlapping thereof with a search area 402 is determined. In FIG. 4A, the search area 402 and the reduced face detection area 405 do not overlap each other. As a result, in the imaging apparatus 1, a frame of the upper half body in the same position and the same size as those of the upper half body detection area 404 is displayed, and a frame of the face is not displayed. The upper half body frame displayed by the display unit 171 may be displayed in the same display form as that of the detection area 404 or may be displayed in a different display form such as dotted lines, blinking, or the like.

Next, FIG. 4B illustrates an example of a state in which the search area 402 has moved upward from the state illustrated in FIG. 4A due to a user's operation on the imaging apparatus such as camera shake or the like. In FIG. 4B, similar to FIG. 4A, overlapping between the reduced face detection area 405 and the search area 402 is determined in the main portion determination. In FIG. 4B, the search area 402 and the reduced face detection area 405 overlap each other. As a result, the imaging apparatus 1 returns the reduced face detection area 405 to its size before the reduction (an area 403 illustrated in the drawing), displays a frame of the face in the same position and the same size as those of the face detection area 403 before the reduction, and does not display a frame of the upper half body. The frame of the face displayed by the display unit 171 may be displayed in the same display form as that of the detection area 403 or may be displayed in a different display form such as solid lines or blinking.

Next, FIG. 4C illustrates an example of a state in which the search area 402 has moved downward from the state illustrated in FIG. 4B due to a user's operation on the imaging apparatus such as camera shake or the like. Since the face of subject 401 has already been set as the main portion in the state illustrated in FIG. 4B, in the state illustrated in FIG. 4C, the imaging apparatus 1 does not reduce the face detection area in the main portion determination and determines overlapping between the face detection area 403 before reduction and the search area 402. In FIG. 4C, the search area 402 and the face detection area 403 overlap each other. For this reason, in the imaging apparatus 1, the state in which the frame of the face is displayed, and the frame of the upper half body is not displayed continues until the state becomes the state illustrated in FIG. 4C from the state illustrated in FIG. 4B. Therefore, according to this embodiment, no switching of the main portion occurs from the state illustrated in FIG. 4B to the state illustrated in FIG. 4C, and flickering accompanying the switching of the display frame in the display unit 171 does not occur.

Therefore, according to the imaging apparatus 1 of this embodiment, for a face of a subject that is preferentially set as a main portion in a captured image, the main portion determination is performed by reducing the face detection area while the face is not set as the main portion. In accordance with this, in the example illustrated in FIGS. 4A to 4C, when the search area 402 overlaps the reduced face detection area 405, the face is set as the main portion. Thereafter, a state in which the face is set as the main portion continues while the search area 402 overlaps the original detection area 403 before reduction. As a result, after the face is set as the main portion, and the display frame of the face is displayed on the display unit 171, the imaging apparatus 1 continuously performs an AF process on the face until the frame of the face and the frame of the search area are separated from each other, and thus, a user can perform intuitive operations on the subject depicted in the image.

Next, modified examples of the first embodiment are described below. In description of each of the following modified examples, the same reference signs will be assigned to configurations and processes that are similar to those of the imaging apparatus 1 according to the first embodiment, and detailed descriptions thereof will be omitted. Each of the following modified examples can also be performed in combination with another modified embodiment and the embodiment described above.

### Modified Example 1

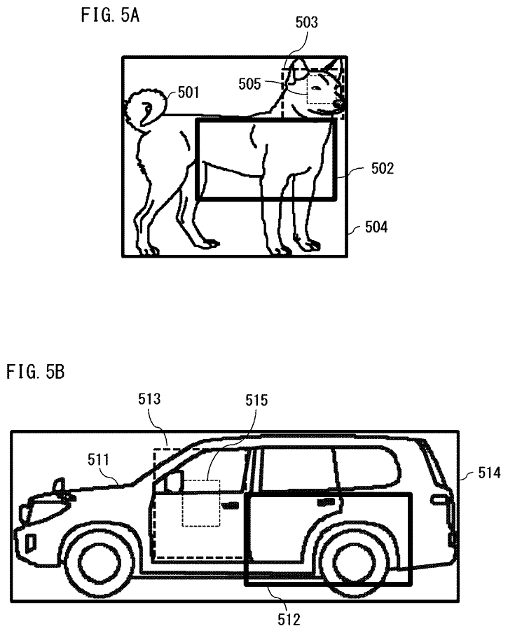

In the embodiment described above, although a case in which the subject is a person is assumed, the subject is not limited to thereto. For example, the subject may be an animal or a vehicle. FIG. 5A illustrates an example of a case in which the subject is a dog 501 as an example of an animal. FIG. 5B illustrates an example of a case in which the subject is an automobile 511 as an example of a vehicle.

As illustrated in FIG. 5A, in a case in which a dog 501 is depicted in the acquired image, the imaging apparatus 1 uses a search area 502, a dog's face (head part) detection area 503, and a dog's whole body detection area 504 in accordance with the process described above. Furthermore, in the imaging apparatus 1, overlapping with the search area 502 is determined using a detection area 505 acquired by reducing the dog's face detection area 503. Here, the search area 502, the face detection area 503, the whole body detection area 504, and the reduced detection area 505 respectively correspond to the search area 402 and the detection areas 403, 404, and 405 according to the first embodiment.

Then, by executing each of the processes described above according to the first embodiment, the imaging apparatus 1 sets a face of the dog 501 as the main portion when the search area 502 and the reduced detection area 505 overlap each other. After the face is set as the main portion, a state in which the main portion is set to the face continues while the search area 502 overlaps the face detection area 503 before reduction. Therefore, switching of the main portion does not occur until the search area 502 and the detection area 503 do not overlap each other, and flickering accompanying switching of the display frame on the display unit 171 does not occur.

Similarly, as illustrated in FIG. 5B, in a case in which an automobile 511 is depicted in the acquired image, the imaging apparatus 1 uses a search area 512, a front door detection area 513 which is a part of the automobile, and a whole automobile detection area 514 in accordance with the process described above. Furthermore, the imaging apparatus 1 determines overlapping with the search area 512 using a reduced detection area 515 acquired by reducing the front door detection area 513 of the automobile. Here, the search area 512, the front door detection area 513, the whole detection area 514, and reduced detection area 515 respectively correspond to the search area 402 and the detection areas 403, 404, and 405 according to the first embodiment.

Then, by executing each of the above-described processes according to the first embodiment, the imaging apparatus 1 sets the front door of the automobile 511 as the main portion when the search area 512 and the reduced detection area 515 overlap each other. After the front door is set as the main portion, a state in which the main portion is set to the front door continues while the search area 512 overlaps the front door detection area 513 before reduction. Therefore, switching of the main portion does not occur until the search area 512 does not overlap the detection area 513, and flickering accompanying switching of the display frame on the display unit 171 does not occur.

In the example described above, the face of the dog 501 and the front door of the automobile 511 are only examples of portions set as main portions, and other parts of the dog 501 and the automobile 511 may be used as portions set as main portions.

### Modified Example 2

In the first embodiment described above, although the detection portions are set as two portions, three or more portions may be detected. In the imaging apparatus 1 according to this modified example, in a case in which three or more portions are to be detected, a priority level relating to setting of the main portion is hierarchically set to each portion, and the main portion determination is performed by reducing the area of a portion having a priority level higher than a portion that is currently the main portion.

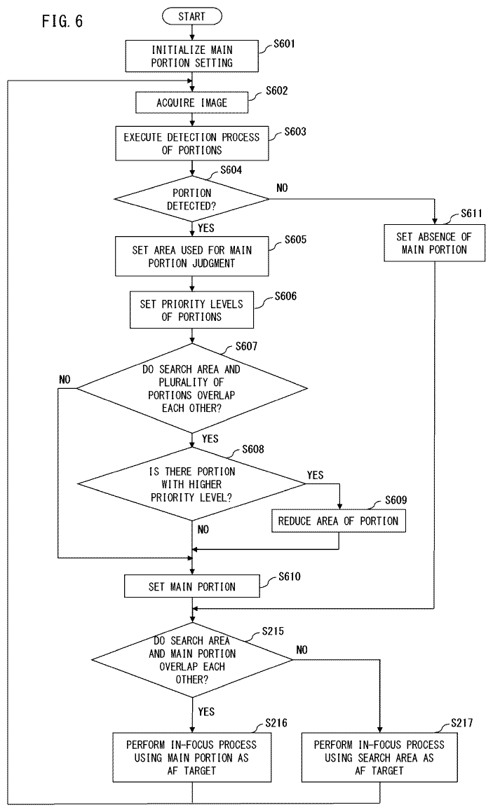

A process performed by the imaging apparatus 1 according to this modified example will be described with reference to FIG. 6. Step S601 and Step S602 respectively correspond to Step S201 and Step S202 according to the first embodiment.

Next, in Step S603, the portion detecting unit 141 executes a detection process for a portion of a subject for an image acquired in Step S202. In this modified example, the portion detecting unit 141 detects a plurality of portions of the subject. Examples of the portions to be detected include a face, an upper half body, a lower half body, a hand, a leg, and the like of a subject. The portions to be detected by the portion detecting unit 141 may be changed as appropriate. A detection result of portions of a subject acquired by the portion detecting unit 141 is sent to the camera control unit 131.

Next, in Step S604, the camera control unit 131 determines whether or not detection of portions of the subject has been successful on the basis of the detection result acquired in Step S603. In a case in which it is determined that portions of the subject in the image have been detected, in other words, detection of portions of the subject has been successful (S604: Yes), the camera control unit 131 causes the process to proceed to Step S605. In addition, in a case in which it is determined that portions of the subject in the image have not been detected, in other words, detection of portions of the subject has failed (S604: No), the camera control unit 131 causes the process to proceed to Step S611.

In Step S605, the main portion setting unit 151 sets an area used for setting the main portion on the basis of portions detected in the image that has been acquired in Step S602. In this embodiment, as an example, the main portion setting unit 151 sets the detection area of the portion detected by the portion detecting unit 141 in Step S603 as an area used for setting the main portion as it is.

In Step S606, the main portion setting unit 151 sets a priority level at the time of being set as the main portion to each portion detected in Step S603. The main portion setting unit 151 is a priority level setting means that sets priority levels relating to the main portions to two or more detected portions. As an example, a hierarchical priority level is set to each detected portion, and the higher the hierarchy to which the priority level is set, the more preferentially the portion is set as the main portion. In this modified example, as an example, it is assumed that the subject is a person, and a priority level of a higher hierarchy is set in order of a lower half body, an upper half body, and a face of the subject. In setting of priority levels, the priority levels may be set on the basis of an arbitrary condition, for example, such as setting higher priority levels in order from the smallest to the largest sizes of areas indicating detected portions in Step S603.

In Step S607, the main portion setting unit 151 determines whether or not the search area overlaps a plurality of areas among areas of portions detected in Step S603 in the image. In a case in which it is determined that the search area overlaps areas of a plurality of portions (S607: Yes), the main portion setting unit 151 causes the process to proceed to Step S608. On the other hand, in a case in which it is determined that the search area does not overlap areas of a plurality of portions (S607: No), the main portion setting unit 151 causes the process to proceed to Step S610.

In Step S608, the main portion setting unit 151 determines whether or not there is a portion to which a priority level higher than that of the currently set main portion is set among the priority levels set in Step S606.

In this modified example, three portions including a lower half body, an upper half body, and a face are detected from a subject, a priority level higher than a priority level set to the lower half body is set to the upper half body, and a priority level higher than the priority level set to the upper half body is set to the face. Thus, for example, in a case in which the main portion is currently set to the lower half body or the upper half body, there is a portion with a higher priority level (the upper half boy in case of the lower half body, and the face in case of the upper half body). For this reason, the main portion setting unit 151 identifies a portion with a higher priority level and causes the process to proceed from Step S608 to Step S609. On the other hand, for example, in a case in which the main portion is currently set to the face, there is no portion with a higher priority level, and thus the main portion setting unit 151 causes the process to proceed from Step S608 to Step S610.

In Step S609, the camera control unit 131 reduces the area of the portion identified as the portion with a higher priority level in Step S607 in the image.

Next, in Step 610, the main portion setting unit 151 sets the main portion on the basis of the area of a portion that overlaps the search area. More specifically, in a case in which two or more areas among a plurality of areas indicating a plurality of portions overlap the search area in the image, the main portion setting unit 151 sets the portion with the highest priority level among the two or more portions corresponding to the two or more areas as the main portion. In addition, the main portion setting unit 151 performs main portion setting for the portion identified in Step S608 as the portion with the higher priority level on the basis of overlapping between the reduced area that has been reduced in Step S609 and the search area. In accordance with this, in a case in which the reduced area, which is acquired by reducing the area of another portion with a higher priority level than that of the portion that is currently set as the main portion, overlaps the search area, the main portion setting unit 151 sets the portion corresponding to the reduced area as the main portion.

As an example, in the case of FIGS. 4A to 4C, the lower half body, the upper half body, and the face of the subject 401 are detected in Step S603, and detection areas 403, 404, and 406 used for main portion determination are set in correspondence with the portions in Step S605. Then, in a case in which the search area 402 overlaps the upper half body detection area 404 and the lower half body detection area 406, the main portion setting unit 151 sets the upper half body with a higher priority level as the main portion. In addition, in a case in which the main portion is not set to the face, the detection area 405 that is a reduced area acquired by reducing the face detection area 403 is set, and, in a case in which the search area 402 overlaps the reduced detection area 405, the main portion setting unit 151 sets the face as the main portion. Since the face of the subject 401 has already been set as the main portion in the state illustrated in FIG. 4B, in the state illustrated in FIG. 4C, the imaging apparatus 1 does not reduce the face detection area in the main portion determination and determines overlapping between the face detection area 403 before reduction and the search area 402. In FIG. 4C, the search area 402 and the face detection area 403 overlap each other. For this reason, in the imaging apparatus 1, a state in which the frame of the face is displayed, and the frame of the upper half body is not displayed continues until the state becomes the state illustrated in FIG. 4C from the state illustrated in FIG. 4B. Therefore, according to this embodiment, no switching of the main portion occurs from the state illustrated in FIG. 4B to the state illustrated in FIG. 4C, and no flickering accompanying the switching of the display frame does not occur on the display unit 171.

Therefore, also in this modified example, after the face with highest priority level among the face, the upper half body, and the lower half body is set as the main portion, and the display frame of the face is displayed on the display unit 171, the imaging apparatus 1 continues to execute the AF process for the face until the frame of the displayed face and the frame of the search area are separated from each other. Thus, similar to the case of the first embodiment, a user can perform intuitive operations on a subject depicted in the image in the imaging apparatus 1.

In Step S611, the main portion setting unit 151 sets absence of the main portion. In accordance with this, a state in which no main portion is set is formed in the captured image acquired in Step S602. Then, the camera control unit 131 causes the process to proceed to Step S215.

Since the processes of Step S215 to Step S217 are the same as those according to the first embodiment, here, detailed description will be omitted.

As above, while the present disclosure has been described in detail on the basis of preferred embodiments thereof, the present disclosure is not limited to these specific embodiments, and various forms in the range not departing from the concept of the present disclosure also belong to the present disclosure. Some of the embodiments described above may be combined as appropriate. In addition, the present disclosure also includes a case in which a software program that realizes the functions of the embodiment described above is supplied to a system or device having a computer capable of executing the program directly from a storage medium or using wired/wireless communication, and the program is executed. Thus, the functional processing of the present disclosure is realized by a computer, and thus a program code that is supplied to and installed in this computer realizes the present disclosure as well. In other words, the computer program itself for realizing the functional processing of the present disclosure is also included in the present disclosure. In such a case, the form of the program such as an object code, a program executed by an interpreter, or script data supplied to the OS is arbitrary, as long as it has the functions of the program. A storage medium for supplying the program may be, for example, a magnetic storage medium such as a hard disk or a magnetic tape, an optical/magneto optical storage medium, or a nonvolatile semiconductor memory. In addition, as a method for supplying a program, a method in which a computer program forming the present disclosure is stored in a server on a computer network, and a connected client computer downloads the computer program and sets the computer program as a program may be also considered.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, by performing main portion determination by reducing a detection area of a portion that is preferentially set as a main portion, the frequency of switching of the main portion accompanying variations in the search area and the detection area of this portion can be reduced.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An imaging apparatus comprising:
a processor; and
a memory storing a program which, when executed by the processor, causes the imaging apparatus to:
execute an acquisition process of acquiring an image of a subject;
execute a detection process of detecting a first portion and a second portion of the subject from the image;
execute an area setting process of setting an arbitrary area in the image as a search area; and
execute a target setting process of setting any one of the first portion and the second portion as a target for image processing in accordance with overlapping between an area representing the first portion and an area representing the second portion, which are detected by the detection process, and the search area,
wherein, in the target setting process, in a state in which the first portion is not set as the target,
even when an area acquired by excluding a reduced area acquired by reducing the area representing the first portion from the area representing the first portion overlaps the search area, the first portion is not set as the target, and
when the reduced area overlaps the search area, the first portion is set as the target.

2. The imaging apparatus according to claim 1, wherein, in the target setting process, in a case in which both the area of the detected first portion and the area of the detected second portion overlap the search area, the first portion is set as the target.

3. The imaging apparatus according to claim 1, wherein, in the target setting process, in a case in which neither the area of the detected first portion nor the area of the detected second portion overlaps the search area, the first portion is set as the target.

4. The imaging apparatus according to claim 1, wherein the image processing is an in-focus process, and
wherein, in the target setting process, in a case in which the first portion and the second portion are not set as the target, the search area is set as the target.

5. The imaging apparatus according to claim 4, wherein, in the target setting process, in a case in which the first portion or the second portion is set as the target, and the area of the first portion or the second portion set as the target does not overlap the search area, the search area is set as the target.

6. The imaging apparatus according to claim 1, wherein the program, when executed by the processor, further causes the imaging apparatus to execute a display process of displaying a frame corresponding to the portion set as the target out of the first portion and the second portion.

7. The imaging apparatus according to claim 1, wherein the subject is a person, the first portion is a face or a head part of the person, and the second portion is an upper half body or a body of the person.

8. The imaging apparatus according to claim 1, wherein the subject is an animal, the first portion is a face of the animal, and the second portion is an entire body of the animal.

9. The imaging apparatus according to claim 1, wherein the subject is a vehicle, the first portion is a part of the vehicle, and the second portion is the entire vehicle.

10. An imaging apparatus comprising:
a processor; and
a memory storing a program which, when executed by the processor, causes the imaging apparatus to:
execute an acquisition process of acquiring an image of a subject;
execute a detection process of detecting two or more portions of the subject from the image;
execute an area setting process of setting an arbitrary area in the image as a search area;
execute a target setting process of setting any one of the two or more portions as a target for image processing in accordance with overlapping between an area representing each of the two or more portions detected in the detection process and the search area; and
execute a priority level setting process of setting a priority level relating to setting of the target to the two or more portions detected by the detection process,
wherein, in the target setting process, in a case in which two or more areas among a plurality of areas representing a plurality of portions overlap the search area, the portion with highest priority level out of the two or more portions corresponding to the two or more areas is set as the target,
in the target setting process, in a state in which another portion with a priority level higher than that of the portion set as the target is not set as the target,
even when an area acquired by excluding a reduced area acquired by reducing the area representing the other portion from the area representing the other portion overlaps the search area, the other portion is not set as the target, and
when the reduced area overlaps the search area, the other portion is set as the target.

11. The imaging apparatus according to claim 10, wherein the priority level is set higher in order from smallest to largest areas of the areas representing the two or more portions.

12. A method of controlling an imaging apparatus, the method comprising:
an acquisition step of acquiring an image of a subject;
a detection step of detecting a first portion and a second portion of the subject from the image;
an area setting step of setting an arbitrary area in the image as a search area; and
a target setting step of setting any one of the first portion and the second portion as a target for image processing in accordance with overlapping between an area representing the first portion and an area representing the second portion, which are detected in the detection step, and the search area,
wherein, in the target setting step, in a state in which the first portion is not set as the target,
even when an area acquired by excluding a reduced area acquired by reducing the area representing the first portion from the area representing the first portion overlaps the search area, the first portion is not set as the target, and
when the reduced area overlaps the search area, the first portion is set as the target.

13. A method of controlling an imaging apparatus, the method comprising:
an acquisition step of acquiring an image of a subject;
a detection step of detecting two or more portions of the subject from the image;
an area setting step of setting an arbitrary area in the image as a search area, and
a target setting step of setting any one of the two or more portions as a target for image processing in accordance with overlapping between an area representing each of the two or more portions detected in the detection step and the search area,
a priority level setting step of setting a priority level relating to setting of the target to the two or more portions detected in the detection step,
wherein, in the target setting step, in a case in which two or more areas among a plurality of areas representing a plurality of portions overlap the search area, the portion with a highest priority level out of the two or more portions corresponding to the two or more areas is set as the target,
in the target setting step, in a state in which another portion with a priority level higher than that of the portion set as the target is not set as the target,
even when an area acquired by excluding a reduced area acquired by reducing the area representing the other portion from the area representing the other portion overlaps the search area, the other portion is not set as the target, and
when the reduced area overlaps the search area, the other portion is set as the target.

14. A non-transitory computer readable medium that stores a program, wherein the program causes a computer to execute a control method of an imaging apparatus, the control method comprising:
an acquisition step of acquiring an image of a subject;
a detection step of detecting a first portion and a second portion of the subject from the image;
an area setting step of setting an arbitrary area in the image as a search area; and
a target setting step of setting any one of the first portion and the second portion as a target for image processing in accordance with overlapping between an area representing the first portion and an area representing the second portion, which are detected in the detection step, and the search area,
wherein, in the target setting step, in a state in which the first portion is not set as the target,
even when an area acquired by excluding a reduced area acquired by reducing the area representing the first portion from the area representing the first portion overlaps the search area, the first portion is not set as the target, and
when the reduced area overlaps the search area, the first portion is set as the target.

15. A non-transitory computer readable medium that stores a program, wherein the program causes a computer to execute a control method of an imaging apparatus, the control method comprising:
an acquisition step of acquiring an image of a subject;
a detection step of detecting two or more portions of the subject from the image;
an area setting step of setting an arbitrary area in the image as a search area;
a target setting step of setting any one of the two or more portions as a target for image processing in accordance with overlapping between an area representing each of the two or more portions detected in the detection step and the search area; and
a priority level setting step of setting a priority level relating to setting of the target to the two or more portions detected in the detection step,
wherein, in the target setting step, in a case in which two or more areas among a plurality of areas representing a plurality of portions overlap the search area, the portion with a highest priority level out of the two or more portions corresponding to the two or more areas is set as the target,
in the target setting step, in a state in which another portion with a priority level higher than that of the portion set as the target is not set as the target,
even when an area acquired by excluding a reduced area acquired by reducing the area representing the other portion from the area representing the other portion overlaps the search area, the other portion is not set as the target, and
when the reduced area overlaps the search area, the other portion is set as the target.
